(19) United States
(12) Patent Application Publication
(10) Pub. No.: US 2004/0169904 A1
(43) Pub. Date: Sep. 2, 2004

(54) Apparatus used with scanner for holding transparent objective film

(76) Inventors: Ming Kuan Qian, Taizhou City (CN); Kun-Yee Yang, Banciao City (TW)

Correspondence Address: SNELL & WILMER, ONE ARIZONA CENTER, 400 EAST VAN BUREN, PHOENIX, AZ, 850040001

(21) Appl. No.: 10/786,691

(22) Filed: Feb. 25, 2004

(30) Foreign Application Priority Data
Feb. 27, 2003 (TW) 92203077

(51) Int. Cl. G02B 26/08

(52) U.S. Cl. 359/198

(57) ABSTRACT

A film holding apparatus for use with a scanner is provided. The film holding apparatus selectively holds a positive film and a negative film, which are respectively supported by a first frame and a second frame. The second frame has a plurality of positioning elements disposed along the longitudinal direction of the second frame. A pair of guiding slots is configured to define a first opening and an opposite second opening, with each respectively allowing the first frame and the second frame to slide into the pair of guiding slots. The second frame is slidable within the pair of guiding slots. The pair of guiding slots has a first side with a first positioning unit, and a second side with a second positioning unit disposed thereon. When the first frame slides into the pair of guiding slots through the first opening, the first positioning unit affixes the position of the first frame. When the second frame slides into the pair of guiding slots through the second opening, the second positioning unit affixes the positions of the positioning elements disposed on the second frame.

### CROSS-REFERENCE TO RELATED APPLICATIONS

This application claims priority of Taiwan Patent Application Serial No. 092203077 entitled “Transparent Object Film Holding Apparatus”, filed Feb. 27, 2003.

### FIELD OF INVENTION

The present invention relates to a film holding apparatus for use with a scanner, and more particularly, to a film holding apparatus used with a scanner for selectively holding a positive film and a negative film to be scanned.

### BACKGROUND OF THE INVENTION

The evolution of multimedia technologies has resulted in significant improvement of imaging peripherals, and scanners have become increasingly important in image output devices. In addition, along with more advances in multimedia applications have come more diverse types of films, such as various types of negative or positive films, to be scanned by scanners, which in turn require more scanners for the application thereof. Accordingly, there is an increasing demand for scanners, which can meet the needs of varying types of films.

Therefore, manufactures have launched certain scanners equipped with additional positive film or negative film holding devices. Such a film holding device is typically designed as a single device for holding either positive films or negative films. However, if a user has a great number of materials in forms of both positive and negative films to process during a short period of time, the user will have to switch between different film holding devices frequently, thus reducing work efficiency.

Furthermore, current film holding devices are substantially separate from the positive or negative films held within them. If any accidental quiver occurs to the scanner during operation, the position of the films to be scanned will slightly change and then affect the quality of image output.

In addition, the positive films are not at the same level with the negative films within the film holding device, which causes uneven light densities to both types of films and results in different effects of image output. Certainly, scanner users would not like this to happen.

### SUMMARY OF THE INVENTION

One aspect of the present invention is to provide a film holding apparatus for use with a scanner to selectively hold a positive film and a negative film that are to be scanned.

Another aspect of the present invention is to provide a film holding apparatus for use with a scanner that can efficiently affix the positions of transparent objects of different thickness to be scanned, such as positive films or negative films, within the film holding apparatus of the scanner.

Yet another aspect of the present invention is to provide a film holding apparatus for use with a scanner that can hold positive films at the same level as the negative films within the film holding apparatus during the scanning process.

In accordance with one embodiment of the present invention, a film holding apparatus includes a pair of guiding slots for selectively holding a positive film and a negative film that are to be scanned. The positive film to be scanned is supported by a first frame, and the negative film to be scanned is supported by a second frame. The pair of guiding slots is configured to define a first opening and an opposite second opening. The first opening and the second opening selectively allow the first frame and the second frame to slide into the pair of guiding slots, respectively through the first opening and the second opening. The pair of guiding slots includes a first positioning unit disposed on a first side of the pair of guiding slots. The first positioning unit has a blocking portion and a guiding portion which face the first opening and second opening respectively. When the first frame slides into the pair of guiding slots through the first opening, the first frame is positioned by the blocking portion of the first positioning unit. The pair of guiding slots further includes a second positioning unit disposed on a second side of the pair of guiding slots. The second frame has a plurality of positioning elements disposed along the longitudinal direction of the second frame with two adjacent positioning elements spacing from each other for a predetermined distance. When the second frame slides into the pair of guiding slots through the second opening, the second frame can slide through the first positioning unit by touching against its guiding portion, and the plurality of positioning elements can be selectively positioned by the second positioning unit.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1a depicts a film holding apparatus for holding a positive film (supported by a first frame) which is to be scanned in accordance with an exemplary embodiment of the present invention;

FIG. 1b depicts the first positioning unit engaging with the first frame in accordance with an embodiment of the present invention;

FIG. 2a depicts a film holding apparatus for holding a negative film (supported by a second frame) which is to be scanned in accordance with an exemplary embodiment of the present invention;

FIG. 2b depicts the second positioning unit engaging with the positioning elements, and

FIG. 2c depicts the convex arc surface of the semicircular positioning spring constrained by the edge of the second frame.

### DETAILED DESCRIPTION

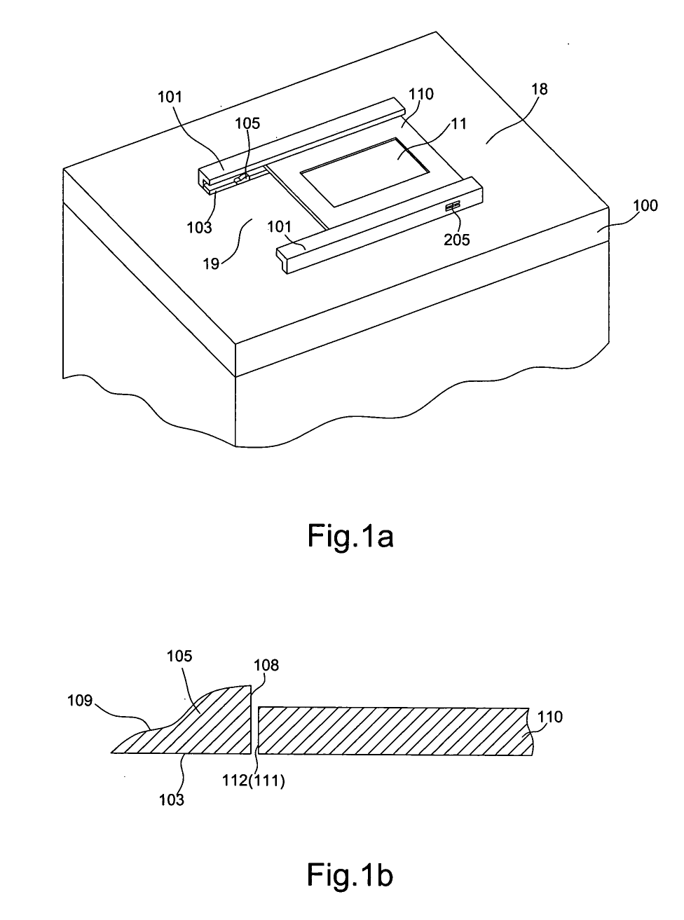

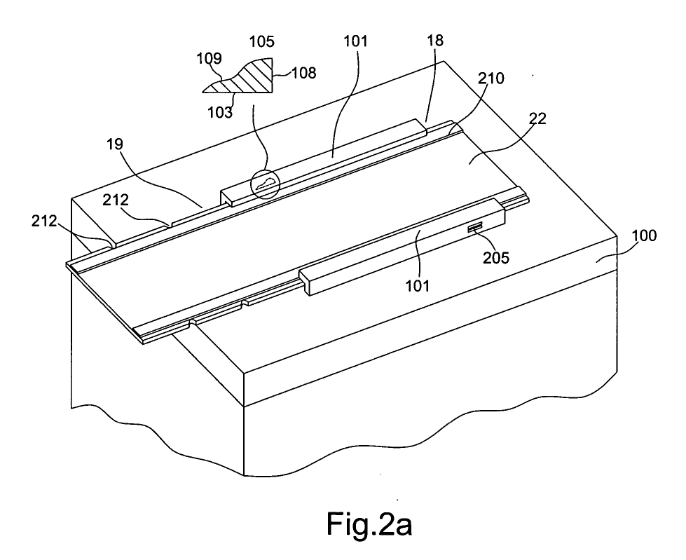

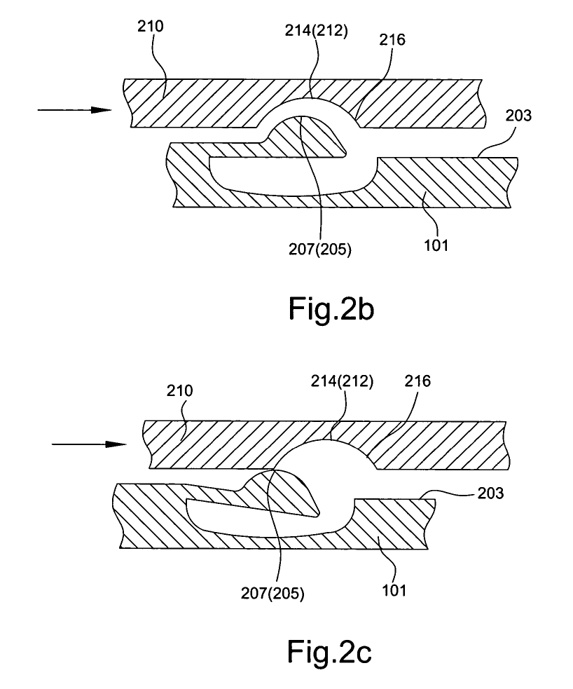

The present invention provides a film holding apparatus for use with a scanner to selectively hold a positive film and a negative film that are to be scanned. As shown in FIG. 1a and FIG. 2a, in one embodiment of the present invention, a positive film 11 to be scanned is supported by a first frame 110, and a negative film 22 to be scanned is supported by a second frame 210.

The exemplary film holding apparatus includes a pair of guiding slots 101 disposed on a platform 100 of the scanner. The pair of guiding slots 101 is configured to define a first opening 18 and a second opening 19. The second opening 19 is opposite to the first opening 18. The first frame 110 and the second frame 210 are selected to slide into the pair of guiding slots 101 through the first opening 18 and the second opening 19 respectively. The second frame 210 is slidable within the pair of guiding slots 101. Referring to FIGS. 1a, 1b, 2a, and 2b, the exemplary film holding apparatus includes at least a first positioning unit 105 disposed on a first side 103 of the pair of guiding slots 101 for affixing the position of the first frame 110. Thus, the positive film 11 supported by the first frame 110 can be located within the pair of guiding slots 101. The exemplary film holding apparatus further includes at least a second positioning unit 205 disposed on a second side 203 of the pair of guiding slots 101 for affixing the position of a positioning element 212 of the second frame 210. Thus, the negative film 22 supported by the second frame 210 can be located within the pair of guiding slots 101. Therefore, as shown in FIG. 1a and FIG. 1b, both the positive film 11 and the negative film 22 can be selectively located at a same level within the same pair of guiding slots 101. Accordingly, through positioning the positive and negative films at the same level of the pair of guiding slots, in accordance with another aspect of the present invention, the output quality of images can be increasingly improved by using the film holding apparatus of the present invention.

FIG. 1a depicts that the exemplary film holding apparatus holds the positive film to be scanned, which is supported by the first frame 110. The film holding apparatus includes the first positioning unit 105 disposed on the first side 103 of the pair of guiding slots 101. In addition, the pair of guiding slots 101 is configured to define the first opening 18 and the opposite second opening 19. When the first frame 110 slides into the pair of guiding slots 101 through the first opening 18, the first positioning unit 105 will affix the position of the first frame 110.

Referring to FIG. 1b, the first positioning unit 105 has a blocking portion 108 facing the first opening 18 and a guiding portion 109 facing the second opening 19. The first frame 110 has a surface 112 on the first side 111 of the first frame 110. The blocking portion 108 is provided to touch against the surface 112 to affix the position of the first frame 110, as shown in FIG. 1b. FIG. 1b depicts the first positioning unit 105 engaging with the first frame 110. In other words, as the first frame 110 slides into the pair of guiding slots 101 through the first opening 18, the surface 112 of the first frame 110 touches against the blocking portion 108 of the first positioning unit 105, so that the first frame 110 carrying the positive film 11 is positioned at a predetermined location within the guiding slots 101. It is noted that the size of the first positioning unit 105 should not hinder the progress of the second frame 210 in accordance with the following-mentioned exemplary embodiment. In other words, the negative film 22 supported by the second frame 210 described hereinafter should be slidable within the pair of guiding slots 101 by touching against the guiding portion 109 of the positioning unit 105.

FIG. 2a depicts that the exemplary film holding apparatus holds the negative film 22 to be scanned, which is supported by a second frame 210. In this exemplary embodiment, the second frame 210 is provided to support the negative film 22. The film holding apparatus includes the second positioning unit 205 disposed on the second side 203 of the pair of guiding slots 101. In addition, the second frame 210 has a plurality of positioning elements 212 disposed along the longitudinal direction of the second frame 210 with two adjacent positioning elements 212 spacing from each other for a predetermined distance, and more preferably, for the distance of one negative film 22. The positioning elements 212 are selectively positioned by the second positioning unit 205. When the second frame 210 slides into the pair of guiding slots 101 through the second opening 19, the second frame 210 is slidable within the pair of guiding slots 101 by touching against the guiding portion 109 of the first positioning unit 105. More specifically, the second frame 210 can move within the pair of guiding slots 101, preferably for the distance of one negative film, with the positioning elements 212 engaging with the second positioning units 205. Through the movement of the second frame 210 within the pair of guiding slots 101, the plurality of positioning elements 212 are selectively positioned by the second positioning unit 205.

Referring to FIGS. 2b and 2c, in this exemplary embodiment, the second positioning unit 205 is a semicircular spring 207, and each positioning element 212 is a recess 214 corresponding to the semicircular positioning spring 207. The recess 214 has a concave arc surface corresponding to the convex arc surface of the positioning spring 207, so the recess 214 can engage with the positioning spring 207 and affix the position of the second frame 210, as shown in FIG. 2b. FIG. 2b depicts that the second positioning unit 205 engages with one positioning element 212. It is noted that the size of the second positioning unit 205 described herein should not hinder the progress of the first frame 110 in accordance with the afore-mentioned exemplary embodiment. In other words, the positive film 11 supported by the first frame 110 can be positioned within the pair of guiding slots 101 by touching against the second positioning unit 205.

For example, with reference to FIGS. 2a, 2b and 2c, when the second frame 210 slides into the pair of guiding slots 101 through the second opening 19 (the same direction as indicated in FIGS. 2b and 2c), the convex arc surface of the semicircular positioning spring 207 is first constrained by the edge of the second frame 210 so that the second frame 210 can pass through. And when the recess 214 of the second frame 210 passes through the semicircular positioning spring 207 within the pair of guiding slots 101, the semicircular positioning spring 207 is accommodated in the corresponding recess 214 to affix the position of the second frame 210, as shown in FIG. 2b. FIG. 2b depicts the second positioning unit 205 engaging with one positioning element 212. When the second frame 210 engages with the semicircular positioning spring 207, the second frame will no longer move forwards. However, if a larger force, preferably greater than the elasticity of the positioning spring 207, is applied to push the second frame 210, the second frame 210 will move forward again, particularly for the distance of one negative film, until the next positioning element 212 engages with the corresponding semicircular positioning spring 207 and returns to the state shown in FIG. 2b. As this process repeats, the negative film 22 supported by the second frame 210 can be selectively positioned. In other words, the position of the negative film 22 is affixed by moving the second frame 210 within the pair of guiding slots 101, preferably for the distance of one negative film; and at the same time engaging each positioning element 212 with the second positioning unit 205.

In addition, it should be noted that the second frame 210 is slidable within the pair of the guiding slots 101 by touching against the guiding portion 109 when sliding into the pair of guiding slots 101 through the second opening 19. This means that the guiding portion 109 of the first positioning unit 105 associated with the first frame 110 does not restrict the movement of the second frame 210 (as shown in FIG. 2a).

Likewise, with reference to FIG. 1a, the first frame 110 carrying the positive film 11 is allowed to move within the pair of the guiding slots 101 by touching against the convex arc surface of the semicircular positioning spring 207 when sliding into the pair of guiding slots 101 through the first opening 18. This means that the convex arc surface of the semicircular positioning spring 207 associated with the second frame 210 does not restrict the movement of the first frame 110 (as shown in FIG. 1a).

As discussed above, in accordance with the exemplary embodiment, the first positioning unit 105 is disposed on the first side 103 of the pair of the guiding slots 101 to affix the position of the positive film 11. The second positioning unit 205 is disposed on the second side 203 of the pair of the guiding slots 101 to affix the position of the negative film 22. However, it should be appreciated that the first positioning unit 105 and the second positioning unit 205 can be provided at two different sides or the same side of the pair of the guiding slots 101 without departing from the sprit of the present invention.

Furthermore, while the film holding apparatus is configured internally on the platform 100 of the scanner in accordance with this exemplary embodiment, in other exemplary embodiments, the film holding apparatus can be configured in various manners such as an additional, external apparatus in connection with the scanner.

The present invention has been described above with reference to preferred embodiments. However, those skilled in the art will understand that the scope of the present invention need not be limited to the disclosed preferred embodiments. On the contrary, it is intended to cover various modifications and equivalent arrangements within the scope defined in the following appended claims. The scope of the claims should be accorded the broadest interpretation so as to encompass all such modifications and equivalent arrangements.

1. A film holding apparatus for use with a scanner, said film holding apparatus being configured to selectively hold a positive film and a negative film to be scanned, said positive film and said negative film being respectively supported by a first frame and a second frame, said film holding apparatus comprising:
a pair of guiding slots configured to define a first opening and a second opening opposite to said first opening, said first opening and said second opening selectively allowing said first frame and said second frame to slide into said pair of guiding slots respectively through said first opening and said second opening; and
a first positioning unit disposed on a first side of said pair of guiding slots, said first positioning unit having a blocking portion and a guiding portion respectively facing said first opening and said second opening;
wherein, said first frame is positioned by said blocking portion as said first frame slides into said pair of guiding slots through said first opening, and said second frame is slidable within said pair of guiding slots by touching against the guiding portion as said second frame slides into said pair of guiding slots through said second opening.

2. The film holding apparatus according to claim 1, further comprising a second positioning unit disposed on a second side of said pair of guiding slots, wherein said second frame has a plurality of positioning elements disposed along a longitudinal direction of the second frame with two adjacent positioning elements spacing from each other for a predetermined distance, and the plurality of positioning elements are selectively positioned by said second positioning unit as said frame slides into said pair of guiding slots through said second opening.

3. The film holding apparatus according to claim 2, wherein said second positioning unit comprises a semicircular positioning spring, and each positioning element is a recess corresponding to said semicircular positioning spring.

4. The film holding apparatus according to claim 3, wherein said semicircular positioning spring has a convex arc surface, and said recess has a concave arc surface corresponding to said convex arc surface for engaging with said convex arc surface to position said second frame.
